(19) United States
(12) Patent Application Publication
(10) Pub. No.: US 2005/0243011 A1
(43) Pub. Date: Nov. 3, 2005

(54) Protection device for a satellite signal receiving component

(76) Inventor: Keith Vernon Hollatz, Milwaukee, WI (US)

Correspondence Address: Raymond M. Galasso;Galasso & Associates LP, P.O. Box 26503, Austin, TX, 78755-0503, US

(21) Appl. No.: 11/117,929

(22) Filed: Apr. 28, 2005

Related U.S. Application Data
(60) Provisional application No. 60/566,997, filed on Apr. 30, 2004.

(51) Int. Cl. H01Q 1/42

(52) U.S. Cl. 343/872

(57) ABSTRACT

A packaged satellite system product comprises a Signal Amplifying Component (SAC), a satellite signal receiver, a satellite dish assembly, a SAC mounting arm and a SAC protective device. The SAC is configured for receiving signals. The satellite signal receiver is configured for processing said signals. The SAC mounting arm has a first end configured for being attached to the satellite dish assembly and a second end configured for being attached to the SAC. The SAC protective device is attachable to at least one of the SAC and the SAC mounting arm and is configured for protecting the SAC from adverse environmental conditions.

### CROSS REFERENCE TO RELATED APPLICATIONS

This patent application claims priority to co-pending United States Provisional Patent Application having Ser. No. 60/566,997 filed Apr. 30, 2004, entitled “Signal Protector”, having a common applicant herewith and being incorporated herein in its entirety by reference.

### FIELD OF THE DISCLOSURE

The disclosures made herein relate generally to satellite dishes and, more particularly, to devices for protecting satellite dish components.

### BACKGROUND

A typical satellite dish apparatus includes a dish having a surface on which signals (i.e., radio frequency signals) are reflected and a signal amplifier that receives and amplifies the signals after they are reflected on the dish. A satellite receiver then interprets the satellite signal for enabling various channels to be viewed. The amplifier is generally referred to as a Low Noise Block converter (i.e., a LNB) and is one example of a Signal Amplifying Component (SAC) of a satellite system. The LNB is positioned in front of the dish in an orientation where signals are reflected and focused (i.e., via the concave shape of the dish) at the LNB.

Signal reception by the LNB is particularly susceptible to being adversely effected by snow and/or ice gathering on a signal impingement surface of the LNB (i.e., the surface through which the signals pass to reach the amplifying hardware of the LNB). Snow and ice reflect the signals. Thus, snow and/or ice gathering on the LNB can impair or preclude operation of the satellite until the snow and/or ice is sufficiently removed from the LNB.

Satellite dish apparatuses are exposed to a variety of adverse environmental conditions. Examples of such adverse environmental conditions include snow, sleet, hail, heavy rain and intense sunlight. With such adverse environmental conditions in mind, satellite dish apparatuses are generally designed to be durable and to withstand the effects of such inclement weather. However, depending on the severity and the length of such adverse environmental conditions, it can and does damage components of satellite dish apparatuses. A typical LNB has a plastic protective cover that resides over the internal components of the LNB. Prolong exposure to direct sunlight can degrade the plastic. A direct strike of sufficiently large hail on the LNB, particular the plastic protective cover, can break the cover and damage the underlying internal components of the LNB. The probability of the plastic protective cover breaking can be increased by degradation of the plastic protective cover from prolong exposure to sunlight.

Therefore, a device that protects the LNB from adverse environmental conditions and that overcomes limitation associated with conventional devices for configured for protecting the LNB and its internal components from adverse environmental conditions would be useful and advantageous.

### SUMMARY OF THE DISCLOSURE

Protective devices in accordance with the present invention protect the Signal Amplifying Component (SAC) of a satellite dish apparatus (E.g., a LNB) from adverse environmental conditions. More specifically, such protective devices limit the LNB from direct exposure to snow, sleet, hail, rain and intense sunlight, which all can adversely effect performance and lifer expectancy of the SAC. Accordingly, the present invention advantageously overcomes one or more shortcomings associated with conventional devices for configured for protecting the SAC and its internal components from adverse environmental conditions.

In one embodiment of the present invention, a protective device kit for a SAC of a satellite dish apparatus comprises a protective body including an interior space configured for having positioned therein the SAC and a portion of a SAC mounting bracket that is connected to the SAC.

In another embodiment of the present invention, a protective device kit for a SAC of a satellite dish apparatus comprises a tubular protective body and means for attaching the tubular protective body to a SAC mounting arm. The tubular protective body includes an interior space configured for having positioned therein a SAC and a portion of a SAC mounting bracket connected to the SAC. The protective body has a diamond-shaped cross sectional profile.

In another embodiment of the present invention, a packaged satellite system product comprises a SAC, a satellite signal receiver, a satellite dish assembly, a SAC mounting arm and a SAC protective device. The SAC is configured for receiving signals. The satellite signal receiver is configured for processing the signals. The SAC mounting arm has a first end configured for being attached to the satellite dish assembly and a second end configured for being attached to the SAC. The SAC protective device is attachable to at least one of the SAC and the SAC mounting arm and is configured for protecting the SAC from adverse environmental conditions.

Turning now to specific aspects of the present invention, in at least one embodiment, the SAC protective device includes a tubular portion and the tubular portion includes an interior space configured for having the SAC and the second end of the SAC mounting bracket positioned therein.

In at least one embodiment of the present invention, the tubular portion has substantially diamond-shaped cross sectional profile.

In at least one embodiment of the present invention, the SAC protective device includes an integral mounting structure configured for being attached to the SAC mounting arm.

In at least one embodiment of the present invention, the integral mounting structure extends from a wall of the protective body and includes a support surface configured for engaging a surface of the SAC mounting arm.

In at least one embodiment of the present invention, the SAC protective device includes a mounting bracket configured for attaching the protective body to the SAC mounting arm.

These and other objects, embodiments advantages and/or distinctions of the present invention will become readily apparent upon further review of the following specification, associated drawings and appended claims.

### BRIEF DESCRIPTION OF THE DRAWINGS

FIG. 1 depicts an embodiment of a protective device in accordance with the present invention.

FIG. 2 is a cross sectional view taken along the line 2-2 in FIG. 1.

FIG. 3 depicts an embodiment of a protective device kit in accordance with the present invention.

FIG. 4. depicts an embodiment of a protective device having an integral mounting structure in accordance with the present invention.

FIG. 5 depicts an embodiment of a self-securing protective device in accordance with the present invention.

FIG. 6 depicts an embodiment of the self-securing protective device of FIG. 5 in an as-fabricated configuration and an expanded configuration.

### DETAILED DESCRIPTION OF THE DRAWING FIGURES

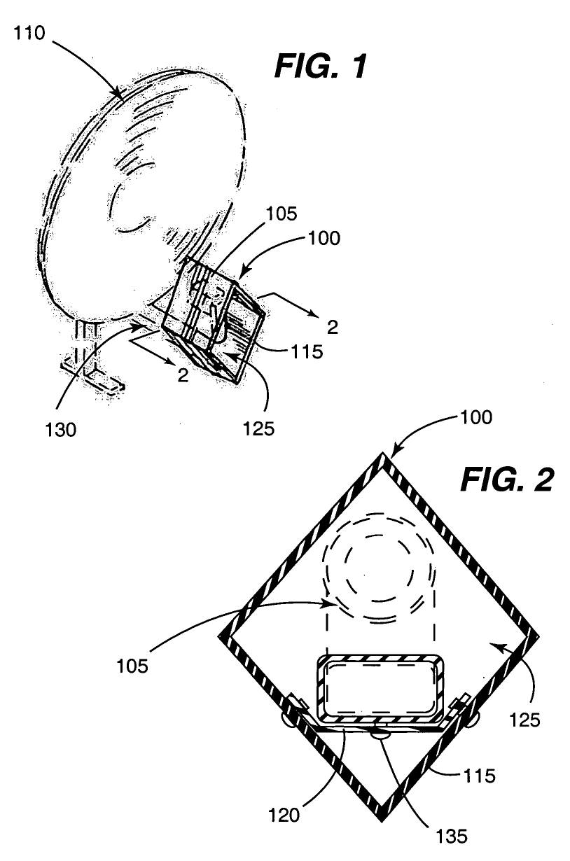

FIGS. 1 and 2 depict an embodiment of a protective device in accordance with the present invention, which is generally referred to as the protective device 100. The protective device 100 is configured for protecting a Low Noise Block converter 105 (i.e., LNB 105) of a satellite dish apparatus 110 from adverse environmental conditions such as snow, sleet, hail, rain and intense sunlight. Exposure to such adverse environmental conditions can adversely affect performance and life expectancy of the LNB 105.

It is disclosed herein that a LNB is a specific example of a Signal Receiving Component (SRC). It is further disclosed that the SRC may be integral with a Signal Transmitting Component (STC), which transmits upstream signal from the satellite dish. Thus, it is disclosed herein that a protective device in accordance with the present invention is configured for protecting a signal transceiver component of a satellite system. A SRC and a STC are individually referred to herein as a Signal Amplifying Component (SAC).

The protective device 100 comprises a protective body 115 and a mounting bracket 120. As depicted in FIGS. 1 and 2, the protective body 115 has a tubular cross sectional profile. The protective body 115 includes an interior space 125 (i.e., as defined by the tubular cross sectional profile) that is configured for having the LNB 105 and, optionally, a portion of the LNB mounting bracket 115 positioned therein. The protective body 125 is preferably made from a polymeric material or laminate material having UV-resistant and high-impact characteristics and the mounting bracket 120 is preferably made from a suitable strong and rigid material such as, for example, aluminium. Placement of the LNB 105 within the interior space 125 of the protective body 115 shields the LNB 105 from direct exposure to adverse environmental conditions. Thus, the likelihood of the LNB being damaged or degraded by such adverse environmental conditions is reduced significantly.

A first portion of the mounting bracket 120 of the protective device 100 is attached to the LNB 105, a LNB mounting arm 130 or both. A second portion of the mounting bracket 120 of the protective device 100 is attached to the protective body 115. In one embodiment, the mounting bracket 120 of the protective device 100, which is a means for attaching the protective body 115, is preferably attached to the LNB mounting arm 130 at a point where a fastener secures the LNB 105 to the LNB mounting arm 130. For example, the mounting bracket 112 is secured to the LNB mounting arm 130 via a fastener 135 (e.g., a screw) that secures the LNB 105 to the LNB mounting arm 130. Similarly, fasteners are used to secure the mounting bracket 120 to the protective body 115.

It is disclosed herein that the primary protection afforded by the protective body 115 is from an upper portion of the protective body 115 when the LNB 105 is in a use position. Accordingly, in other embodiments of the protective body 115 (not shown), a lower portion of the protective body 115 may be omitted. For example, a protective body having an open side (e.g., a U-shaped protective body, semicircular protective body, etc) would generally provide desired shielding functionality (i.e., a closed side residing over the LNB 105 when the LNB is in a use position).

Turning now to FIG. 3, an embodiment of a protective device kit in accordance with the present invention is depicted, which is generally referred to as the protective device kit 200. The protective device kit 200 includes the protective body 115 and the mounting bracket 120 depicted in FIGS. 1 and 2. As depicted in and discussed in reference to FIG. 2, the mounting bracket 120 is attachable to the protective body 115 and to a satellite dish apparatus in a manner for enabling the protective body 115 to protect an LNB of the satellite dish apparatus. The protective device kit 200 may include other items (e.g., fasteners and/or instructions), which are not specifically shown in FIG. 3.

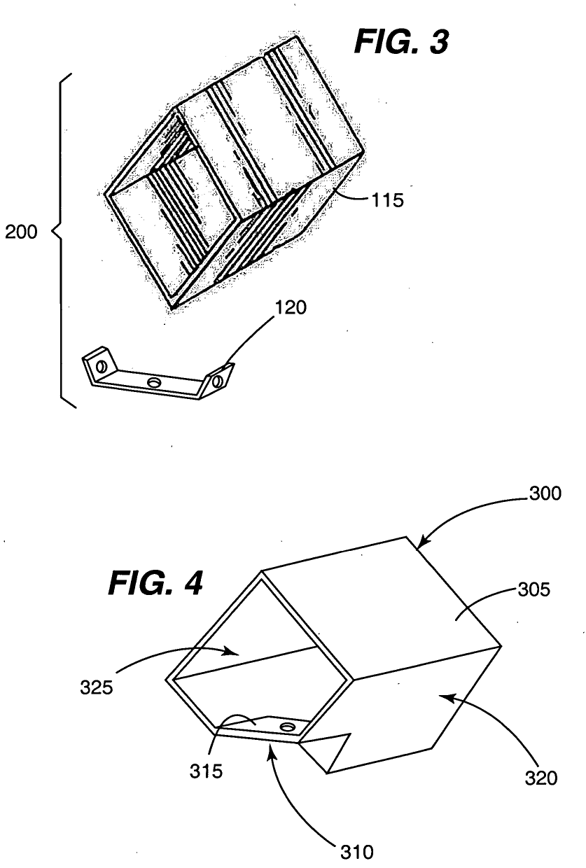

FIG. 4 depicts an embodiment of a protective device (referred to generally as the protective device 300) having an integral mounting structure in accordance with the present invention. The protective device 300 includes a protective body 305 having an integral mounting structure 310. The integral mounting structure 310 extends from a wall of the protective body 305 and includes a support surface 315 configured for engaging a surface of a LNB mounting arm, an LNB or both. As depicted, the protective body 305 includes a tubular portion 320 and the interior space 325 defined by the tubular portion 320. In one embodiment, a protective device kit in accordance with the present invention includes the protective device 300 and, optionally, required fastener(s).

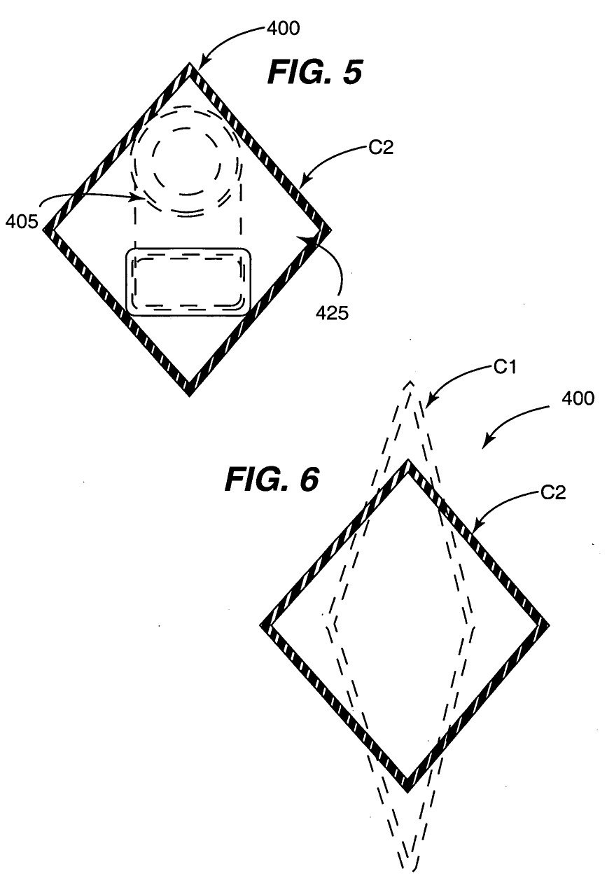

FIGS. 5 and 6 depict an embodiment of a self-securing protective device in accordance with the present invention, which is generally referred to as the protective device 400. The self-securing protective device 400 is similar in form to the protective body 115 depicted in FIGS. 1 and 2. The distinguishing aspect of the self-securing protective device 400 is that discrete and/or integral mounting means are used for securing the self-securing protective device 400 in place.

In one embodiment, the self-securing protective device 400 is formed as a sleeve that is expandable for allowing the self-securing protective device 400 to be installed over the LNB 405 and held in place via compressive force. The compressive force is generated by the self-securing protective device 400 attempting to return to an as-fabricated configuration C1 (i.e., a relatively flat sleeve) from an expanded configuration C2. Through friction and physical engagement, the compressive force results in the LNB 405 remain within an interior space 425 of the self-securing protective device 400 in substantially fixed engagement.

It will be appreciated by the skilled person that a protective device in accordance with the present invention (e.g., the protective device 400 depicted in FIGS. 5 and 6) is not limited to a particular cross sectional profile shape. For example, the protective device 400 could have a generally oval shape when in the expanded configuration and perform the required as-installed functionality suitably well. Similarly, the protective device 100 depicted in FIGS. 1 and 2 could have a generally oval shape and perform the required as-installed functionality suitably well.

A packaged satellite system product in accordance with the present invention includes a protective device in accordance with the present invention. Such a packaged satellite system kit includes a LNB configured for receiving signals, a satellite signal receiver configured for processing the signals, a satellite dish assembly (i.e., a dish and associated mounting bracket(s)), a LNB mounting arm having a first end configured for being attached to the satellite dish assembly and a second end configured for being attached to the LNB and a LNB protective device in accordance with the present invention (e.g., the protective device 100 or the protective device 300).

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A protective device kit for a Signal Amplifying Component (SAC) of a satellite dish apparatus, comprising:
a protective body including an interior space configured for having positioned therein a SAC and a portion of a SAC mounting bracket that is connected to the SAC.

2. The protective device kit of claim 1, further comprising:
a mounting bracket configured for attaching the protective body to the SAC mounting arm.

3. The protective device kit of claim 2 wherein:
the protective body includes a tubular portion; and
the interior space is defined by the tubular portion.

4. The protective device kit of claim 3 wherein the tubular portion has a diamond-shaped cross-sectional profile.

5. The protective device kit of claim 1 wherein:
the protective body includes a tubular portion; and
the interior space is defined by the tubular portion.

6. The protective device kit of claim 1 wherein the protective body includes an integral mounting structure configured for being attached to the SAC mounting arm.

7. The protective device kit of claim 6 wherein:
the integral mounting structure extends from a wall of the protective body; and
includes a support surface configured for engaging a surface of the SAC mounting arm.

8. The protective device kit of claim 7 wherein:
the protective body includes a tubular portion; and
the interior space is defined by the tubular portion.

9. A protective device kit for a Signal Amplifying Component (SAC) of a satellite dish apparatus, comprising:
a tubular protective body including an interior space configured for having positioned therein a SAC and a portion of a SAC mounting bracket connected to the SAC, wherein the protective body has a diamond-shaped cross sectional profile; and
means for attaching the tubular protective body to the SAC mounting arm.

10. The protective device kit of claim 9 wherein said means for mounting includes one of:
a mounting bracket configured for attaching the protective body to the SAC mounting arm; and
a mounting structure that is integrally formed with tubular protective body and that includes a support surface configured for engaging a surface of the SAC mounting arm.

11. A packaged satellite system product, comprising:
a Signal Amplifying Component (SAC) configured for receiving signals;
a satellite signal receiver configured for processing said signals;
a satellite dish assembly;
a SAC mounting arm having a first end configured for being attached to the satellite dish assembly and a second end configured for being attached to the SAC;
a SAC protective device attachable to at least one of the SAC and the SAC mounting arm, wherein the SAC protective device is configured for protecting the SAC from adverse environmental conditions.

12. The packaged satellite system product of claim 3 wherein:
the SAC protective device includes a tubular portion; and
the tubular portion includes an interior space configured for having the SAC and the second end of the SAC mounting bracket positioned therein.

13. The packaged satellite system product of claim 4 wherein the tubular portion has substantially diamond-shaped cross sectional profile.

14. The packaged satellite system product of claim 4 wherein the SAC protective device includes an integral mounting structure configured for being attached to the SAC mounting arm.

15. The packaged satellite system product of claim 3 wherein the SAC protective device includes an integral mounting structure configured for being attached to the SAC mounting arm.

16. The packaged satellite system product of claim 3 wherein:
the SAC protective device includes a protective body; and
a mounting bracket configured for attaching the protective body to the SAC mounting arm.

17. The packaged satellite system product of claim 8 wherein the protective body includes an interior space configured for having the SAC and the second end of the SAC mounting bracket positioned therein.
